(19) United States
(12) Patent Application Publication
(10) Pub. No.: US 2003/0230657 A1
(43) Pub. Date: Dec. 18, 2003

(54) Primary reduction apparatus

(76) Inventor: John Dorscht, Kitchener (CA)

Correspondence Address: BORDEN LADNER GERVAIS LLP, WORLD EXCHANGE PLAZA, 100 QUEEN STREET SUITE 1100, OTTAWA, ON, K1P 1J9, CA

(21) Appl. No.: 10/170,429

(22) Filed: Jun. 14, 2002

(51) Int. Cl. B02C 18/18

(52) U.S. Cl. 241/243; 241/294

(57) ABSTRACT

A primary reduction apparatus having a frame structure and at least one shaft mounted on the frame. The shaft is reversibly rotatable around an axis of rotation in a first direction of rotation or a second direction of rotation. A drive supplies rotation force to rotate the shaft. Protruding cutters are arranged on the shaft, each cutter having a stem portion which edges define shear edges, a first protruding wedge-shaped tooth arranged on the stem portion and facing the first direction of rotation and a second protruding wedge-shaped tooth facing the second direction of rotation. Cross members connect sides of the frame with cracker jaw plates removably attached to each cross member. The cracker jaw plates have a working surface with multiple pierce points forming a serrated edge to cooperate with the cutters. The cracker jaw plates have a relief on a surface of the cracker jaw plates facing the cutter and are removably attached to the cross members. The cross-members are similarly removably attached to the frame. The frame structure has an enclosure provided with a charging opening for material to be shredded, and a discharging opening for shredded material. The drive has either an internal combustion engine or an electric motor used as prime mover. The prime mover provides pressurized hydraulic fluid to a hydraulic motor, which provides the rotation force to the shaft. A pressure sensing means is connected to the drive to automatically reverse the shaft rotation directions when the pressure sensing means senses an over-pressure situation. The drive has a timer to periodically reverse the shaft rotation direction. A plurality of vertically extendible and contractible legs are attached to the frame and provide support for the shredding apparatus during shredding.

### BACKGROUND OF THE INVENTION

1. Field of the Invention

This invention relates to comminuting or shredding apparatuses, and particularly to shredders having a rotating shaft provided with protruding cutters.

2. Description of the Prior Art

Traditionally, a rotating shaft comminuting apparatus has one or more shafts provided with teeth or other protrusions, which cooperate with non-rotating anvil structures to break up material. Comminuting apparatuses of this type are disclosed in U.S. Pat. No. 3,703,970 (Benson), U.S. Pat. No. 5,320,293 (Laly et al.) and U.S. Pat. No. 5,094,392 (Szombathy), for example.

The traditional comminuting apparatuses all share a number of apparent disadvantages and drawbacks. They are relatively complicated in their shaft teeth/anvil structure, which makes their manufacture expensive. When the shaft teeth/anvil structure gets worn, it is complicated, and therefor expensive, to replace or repair this structure. The teeth have to be cut off and new teeth welded in place, or a new shaft have to be installed and the old shaft sent for repair. The anvil structure has to be cut off and a new structure welded on, when the anvil structure is worn out. Conventional shredding equipment generally process single materials, does not tolerate abrasives or tramp iron, and typically has multiple shafts.

### SUMMARY OF THE INVENTION

It is an object of the invention to mitigate and/or obviate the above mentioned disadvantages and drawbacks to provide a shredding apparatus, which is easy and cheap to manufacture and assemble and which provides the required shredding capacity.

A further object of the invention is to provide a shredding apparatus, which processes materials by shredding, crushing, breaking, splitting, tearing and shearing using a minimum of power, thereby making it possible to use low output power sources for high efficiency.

Still a further object of the invention is to provide a shredding apparatus, which provides a reversible shaft having equal shredding capabilities in either direction of rotation, to effect re-flow and agitation of the material to be shredded.

A further object of the invention is to provide a shredding apparatus, in which the smaller size material, which is not required to be sized, freely falls through the shredding shaft and cutter deck construction, to reduce wear and tear on the wear elements.

In the invention, a shredding apparatus has a frame structure and a shaft mounted on the frame. The shaft is reversibly rotatable around an axis of rotation in a first direction of rotation or a second direction of rotation. A reversible drive means supplies rotation force to rotate the shaft. At least one protruding cutter is arranged on the shaft, each cutter having a stem portion which edges define shear edges, a first wedge-shaped tooth arranged on the stem portion and facing the first direction of rotation and a second wedge-shaped tooth arranged on the stem portion and facing the second direction of rotation. Further, at least one cross-member connects sides of the frame. Cracker jaw plates are removably attached to each cross-member, the cracker jaw plates having a working surface with multiple pierce points forming a serrated edge to cooperate with the cutters. Material to be shredded is first contacted by the first tooth or the second tooth, depending upon the direction of rotation of the shaft, then pushed towards the serrated edge of one of the cracker jaw plates, and second is sheared between an edge of the working surface of the cracker jaw plates and one of the shear edges of the stem portion of the cutters.

Alternatively, more than one shaft may be used in the shredder apparatus to enlarge the shredding capacity by enlarging the physical dimensions of the cutter deck. The cracker jaw plates advantageously have a relief on a surface of the cracker jaw plates facing the cutter to provide further shearing edges to cooperate with the serrated edge of the cracker jaw plate.

The cutters are further advantageously removably attached to the shaft.

The cross-members are similarly advantageously removably attached to the frame.

Advantageously, the frame structure has an enclosure provided with a charging opening for material to be shredded and a discharging opening for shredded material.

In one embodiment of the invention, the reversible drive means comprises at least one internal combustion engine used as prime mover. Alternatively, the reversible drive means comprises at least one electric motor used as prime mover. The prime mover provides pressurized hydraulic fluid to a hydraulic motor, which provides the rotation force to the shaft.

The reversible drive means further advantageously comprises a pressure sensing means connected to automatically reverse the shaft rotation directions when the pressure sensing means senses an over-pressure situation, which would be the case when material to be shredded is beyond the capacity of the shredder.

The reversible drive means further preferably comprises a timer arrangement to periodically reverse the shaft rotation direction.

The shredding apparatus further comprises a plurality of vertically extendible and contractible legs, to provide support for the shredding apparatus during shredding. The shredding apparatus can be operated with the legs extended or retracted, depending upon the required height above ground etc.

The shredding apparatus according to the invention provides an efficient double shear during shredding using jaw plates with double shear edges. Further, an aggressive material processing is provided due to the single tooth protrusion and shape. The interaction between the cutter and the serrated jaw plate provides a high efficiency pierce and shear action. The shredding apparatus has multiple material capabilities and a built-in tramp iron protection. Thus, the efficiency, capability and capacity of the system is improved, with additional piercing action provided by the serrations on the cracker jaw plates.

Further features of the invention will be described or will become apparent in the course of the following detailed description.

### BRIEF DESCRIPTION OF THE DRAWINGS

In order that the invention may be more clearly understood, the preferred embodiment thereof will now be described in detail by way of example, with reference to the accompanying drawings, in which:

FIG. 1 is a perspective side view of a shredding apparatus according to one embodiment of the invention;

FIG. 2 is a top view of the shredding apparatus of FIG. 1;

FIG. 3 is a perspective detail view from below of the shredding apparatus of FIG. 1, showing the apparatus with the enclosure removed from the frame to show the wedge system used to hold the cross members in place on the frame;

FIG. 4 is an exploded perspective detail view of a shaft, a cutter and a cross member with associated cracker jaw plates, shims and key plates according to one embodiment of the invention;

FIG. 5A is a perspective side view of a cracker jaw plate of a shredding apparatus according to one embodiment of the invention,

FIG. 5B is a plan view of the cracker jaw plate of FIG. 5A;

FIG. 6 is a sectioned side view of the cracker jaw plate of FIG. 5A;

FIG. 7A is an assembled detail end view of the shaft, the cutter and the cross member with associated cracker jaw plates, shims and key plates of FIG. 4, showing the cutter in a position where its cutting point first contacts the material to be shredded;

FIG. 7B is an assembled detail end view of the shaft, the cutter and the cross member with associated cracker jaw plates, shims and key plates of FIG. 4, showing the cutter in a position where its shearing edge first contacts the material to be shredded, and shears the material in cooperation with the first and second shearing edges of the cracker jaw plate;

FIG. 7C is an assembled detail end view of the shaft, the cutter and the cross member with associated cracker jaw plates, shims and key plates of FIG. 4, showing the cutter in a position where its shearing edge has rotated further along the first and second shearing edges of the cracker jaw plate;

FIG. 7D is an assembled detail end view of the shaft, the cutter and the cross member with associated cracker jaw plates, shims and key plates of FIG. 4, showing the cutter in a position where its shearing edge has rotated still further along the first and second shearing edges of the cracker jaw plate, so that the shearing edge of the cutter is no longer cooperating with the first and second shearing edges of the cracker jaw plate;

FIG. 8 is a perspective view of a shaft according to a further embodiment of the invention, showing multi-piece cutters;

FIG. 9 is a perspective detail view of a multi-piece cutter of FIG. 8;

FIG. 10 is an exploded perspective detail view of the multi-piece cutter of FIG. 9; and

FIG. 11 is a perspective detail view of a cutter having replaceable tips.

### DETAILED DESCRIPTION OF THE PREFERRED EMBODIMENT

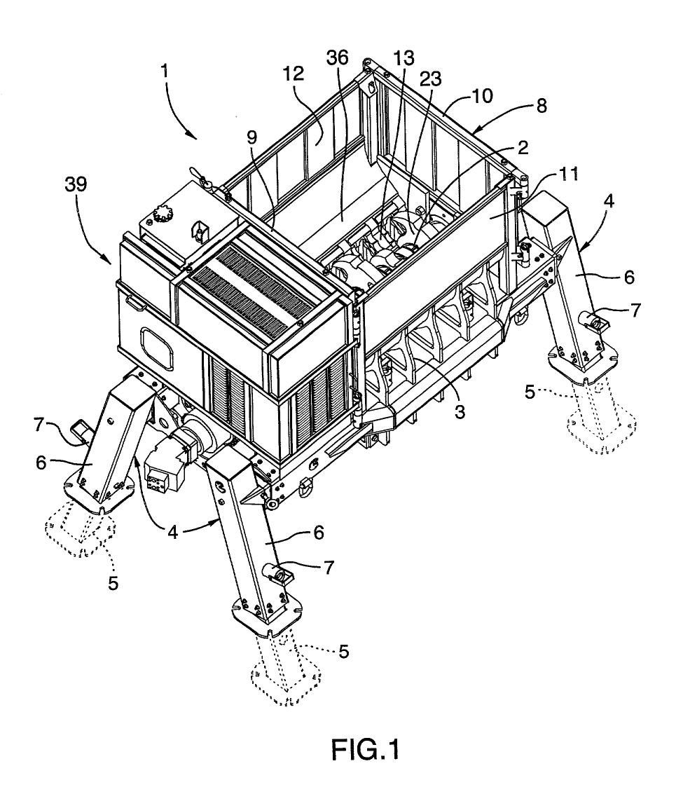

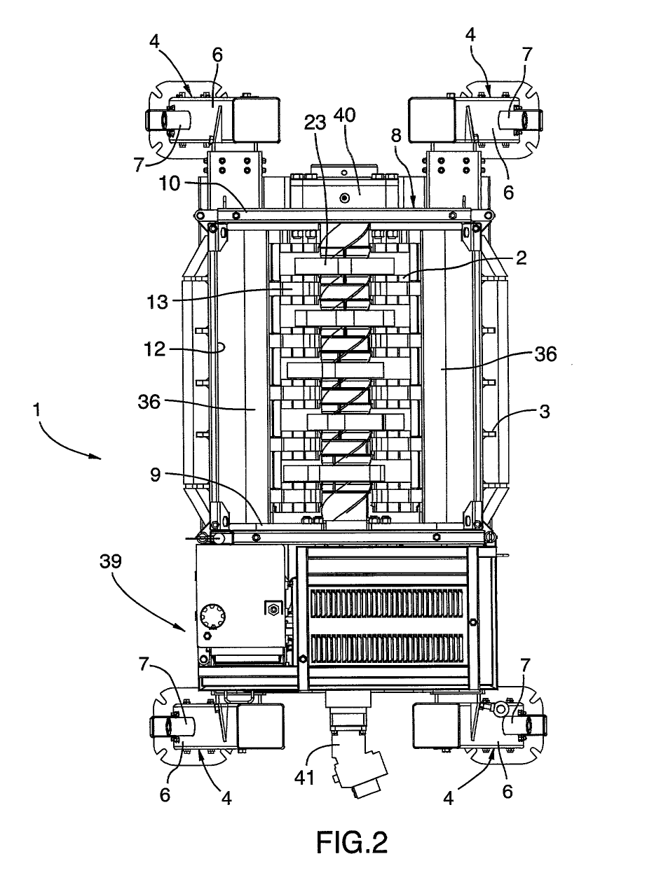

Referring to FIGS. 1 to 2, a shredding apparatus 1 according to the invention has a rotatable shaft 2 held by a frame 3, which is preferably of a generally rectangular shape held in a substantially horizontal plane. Attached to the frame are advantageously leg assemblies 4, arranged on opposite sides of the frame, preferably one leg assembly at each corner of the frame to provide stability to the shredder. The leg assemblies have an extendible portion 5 slidably arranged inside a housing portion 6.

The shredding apparatus 1 is transported with the leg assemblies 4 in their retracted positions, i.e. the extendible portions 5 are fully retracted into the housing portions 6, and are locked in the fully retracted position using leg locking means 7 arranged on the housing portions. The shredding apparatus thus rests on the housing portions, minimizing the height of the shredding apparatus. The shredding apparatus can be operated with the legs extended or retracted, depending upon the required height of the cutter deck above ground or shredded material collector underneath the shredding apparatus.

In preparing the shredding apparatus 1 for use, for example at a building site where waste material is to be shredded, the transport vehicle (not shown) is parked at the desirable shredding site and the shredder is lifted to its intended shredding location. The leg assemblies 4 are fully extended and locked in place using the leg locking means 7 arranged one on each housing portion 6, thereby holding the shredding apparatus 1 at its upper working height for shredding. Shredding can be performed either using a collection means for the shredded material, for example a container (not shown), or shredding directly onto the ground.

The shredding apparatus 1 further comprises an enclosure 8 (hopper), substantially surrounding a space above the shaft 2. The enclosure preferably has a back 9, a hinged swinging end door 10, a first side 11 and a second side 12. The enclosure defines a charging opening for the shredder.

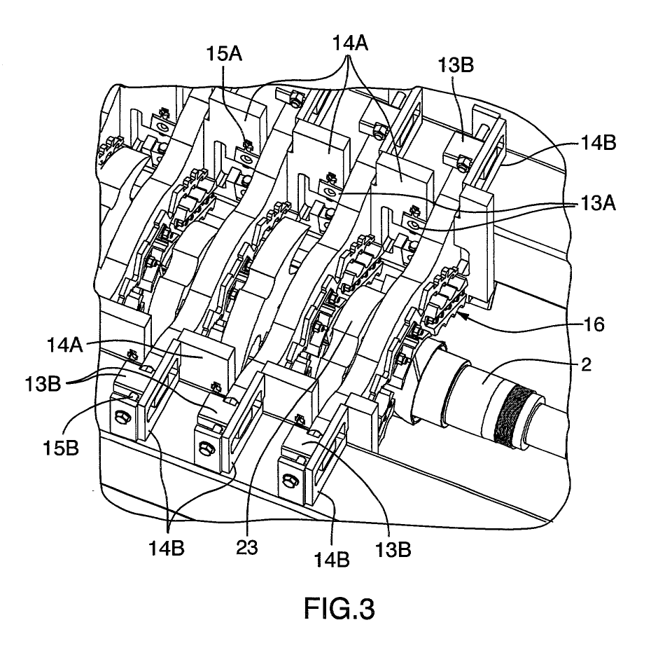

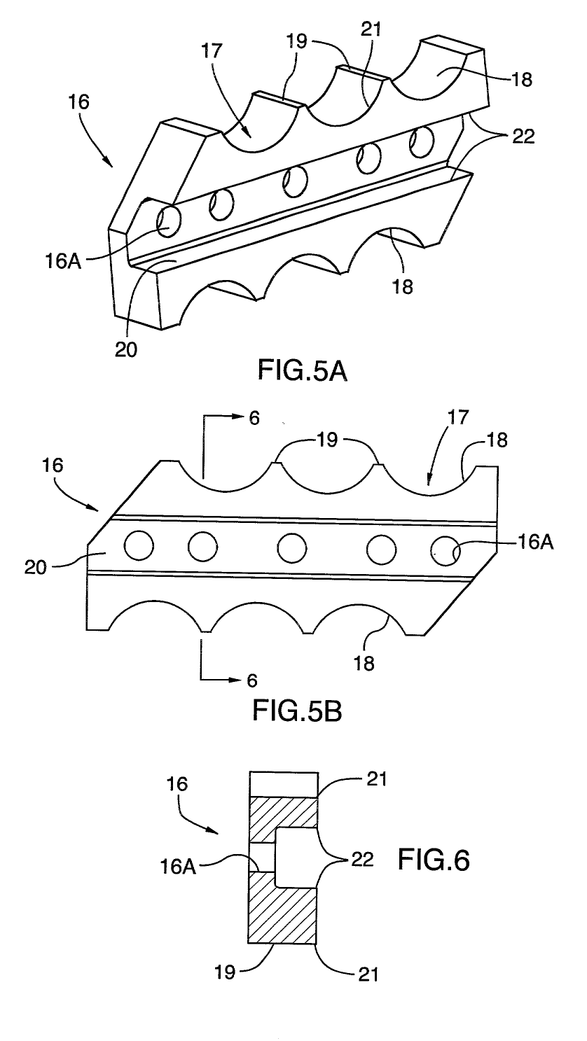

As is shown in FIGS. 2, 3, 4, and 7A to D, the shaft 2 is supported on the frame 3 by cross members 13. The cross-members are advantageously removably attached to the frame, for instance using a wedge-in system (see FIG. 3) having wedges 13A and 13B cooperating with wedge plates 14A and 14B, respectively. The wedge plates are firmly fastened to the frame. Each wedge is attachable to the frame using a bolt-and-nut arrangement 15A and 15B, respectively, so that each wedge can be tightened towards the frame to thus exert pressure on the wedge plates and thereby securely wedge each cross member 13 in place relative the frame 3. Alternatively, the cross-members are bolted or welded directly to the frame (not shown). Each cross member has cracker jaw plates 16 removably attached in a position facing the enclosure 8. The cracker jaw plates (see FIGS. 5A to 6) have serrated surfaces 17 along each of two opposing sides 18, forming multiple pierce points 19, the pierce points create tear lines in the material to be shredded to enhance the shredding process. A relief 20 is arranged on one side of the jaw plates, between the two opposing sides. An edge 21 of the serrated surfaces and edges 22 of the relief form shearing edges, which are cooperating with cutters 23 arranged on the shaft 2. Thus, the relief provides a double shear. The cracker jaw plates 16 are advantageously symmetrical, so they can be removed from the cross members 13 and mounted again in a reversed position, for doubled life. Mounting holes 16A are used to attach the cracker jaw plates to the cross members.

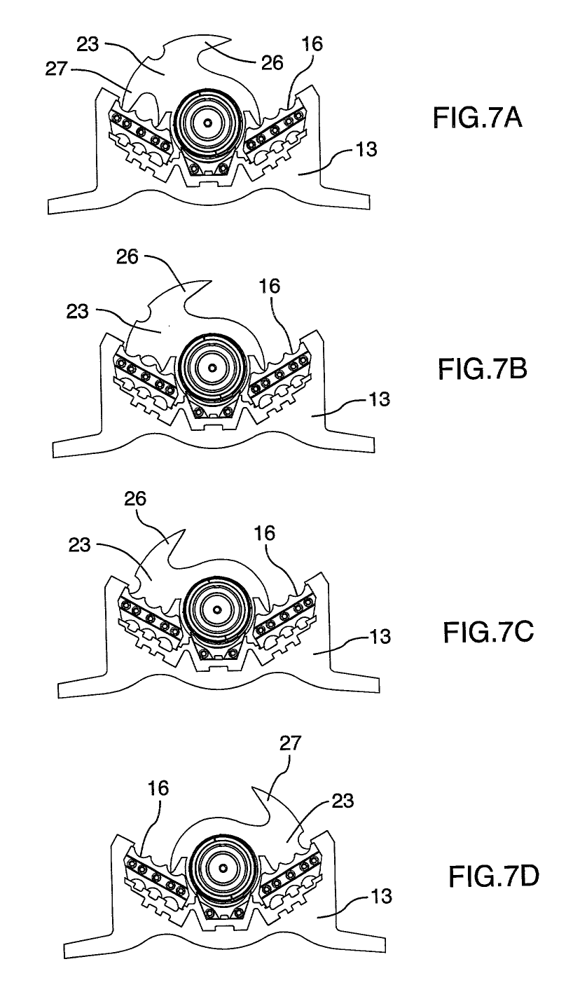

The cutters have a stem portion 24. Further, a first wedge-shaped single tooth 26 is arranged on the stem portion and facing a first direction of rotation and a second wedge-shaped single tooth 27 is arranged on the stem portion and facing a second direction of rotation. Inner edges of the first tooth and the second tooth define shear edges 25. Each tooth first pierces the material to be shredded, during operation of the shredder, then splits the material using the wedge principle, using minimal input force to create maximum splitting results. The teeth are advantageously made to the full thickness of the cutters, to enhance their resilience. The shear edges 25 of the cutter creates a wedge type shearing action of the material to be shredded against the cracker jaw plates 16 edges and the relief 20 edges, see FIGS. 7A to D. The curved shear edge 25 thus draws material to be shredded in towards the shaft where the available torque is higher. The relief further reduces friction between the cracker jaw plate and the cutter caused by material to be cut that is caught between them.

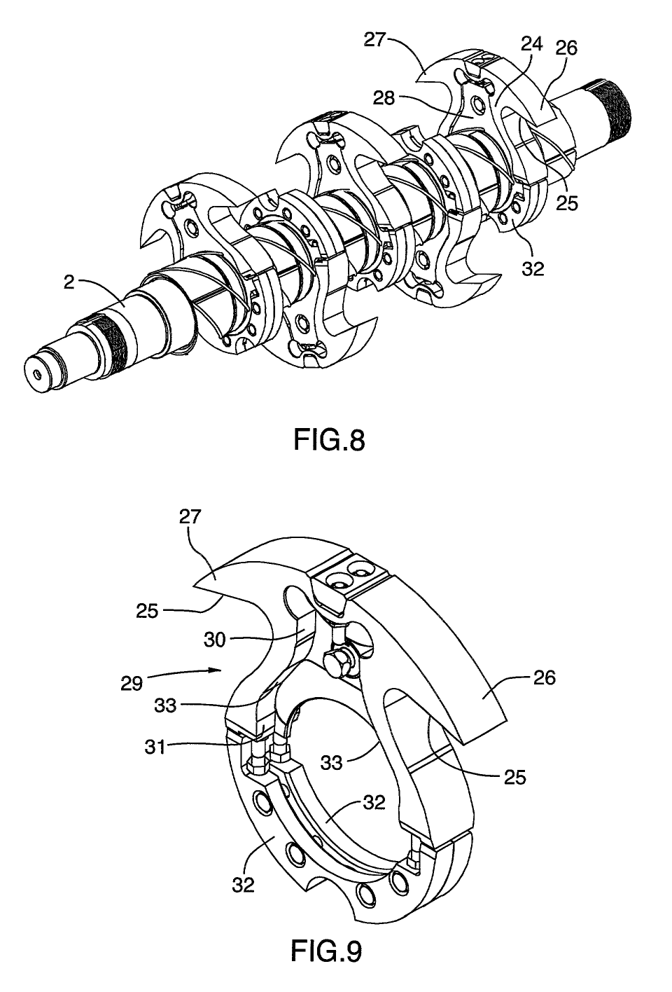

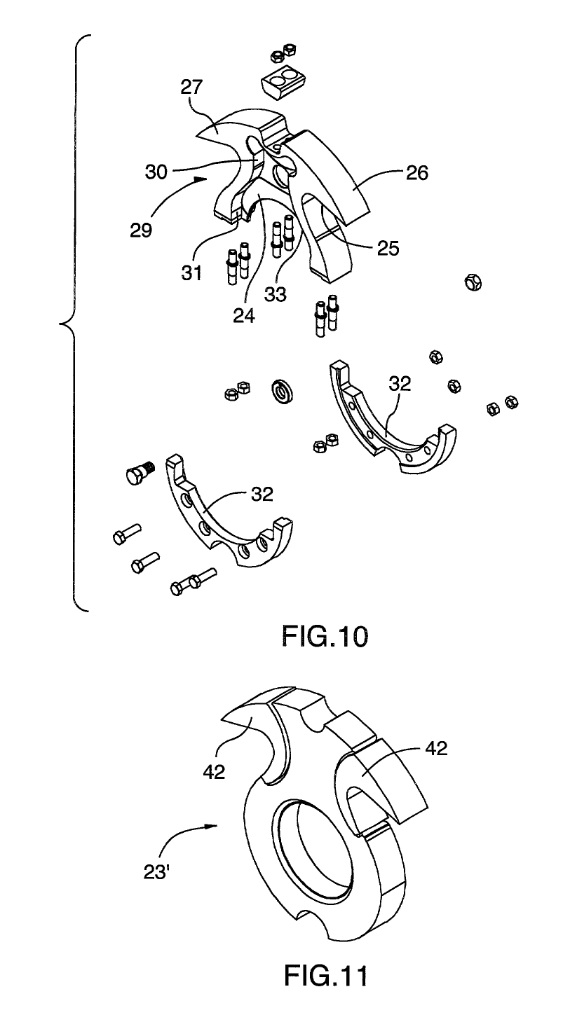

The cutters 23 are removably fastened onto the shaft 2, either by being welded on or by being bolted on. A welded on cutter has to be cut off the shaft to be replaced, a multi-piece cutter that is bolted on (see FIGS. 8 to 10) can be easily unbolted and replaced. A multi-piece cutter is bolted to protrusions 28 permanently fastened to the shaft 2. A main portion 29 has the stem portion 24, with edges that define shear edges 25, and the first wedge-shaped tooth 26 and the second wedge-shaped tooth 27. Machined surfaces 30 and 31 of the main portion abut surfaces of the protrusions 28, to properly locate the main portion relative the shaft. The main portion is fastened to the protrusion for example using a bolt and nut. Capped covers 32 are bolted to the protrusions 28 to protect the main portion fastening bolts or lugs. The main portion advantageously has second shear edges 33 providing a further shearing against the cracker jaw plate shear edges during the rotation of the cutter.

FIG. 11 shows a further embodiment of a cutter 23′ according to the invention, having removable tips 42. The tips are advantageously welded on and are cut off the cutter 23′ when they have to be replaced (a new tip 42 welded on).

Each end of the shaft is held in a bearing 40 (FIG. 2) arranged on the frame 3, to securely and rotatably hold the shaft in position. Advantageously, each cross member 13 has shaft strippers 34 to remove material wrapped around the shaft during operation of the shredding apparatus. The shaft strippers are advantageously removably attached to each cross member.

The shaft 2 is advantageously covered with hard-facing split sleeves 35, to protect the shaft from excessive wear. The sleeves are easily replaceable when replacing the cutters by removing the sleeve halves from the shaft.

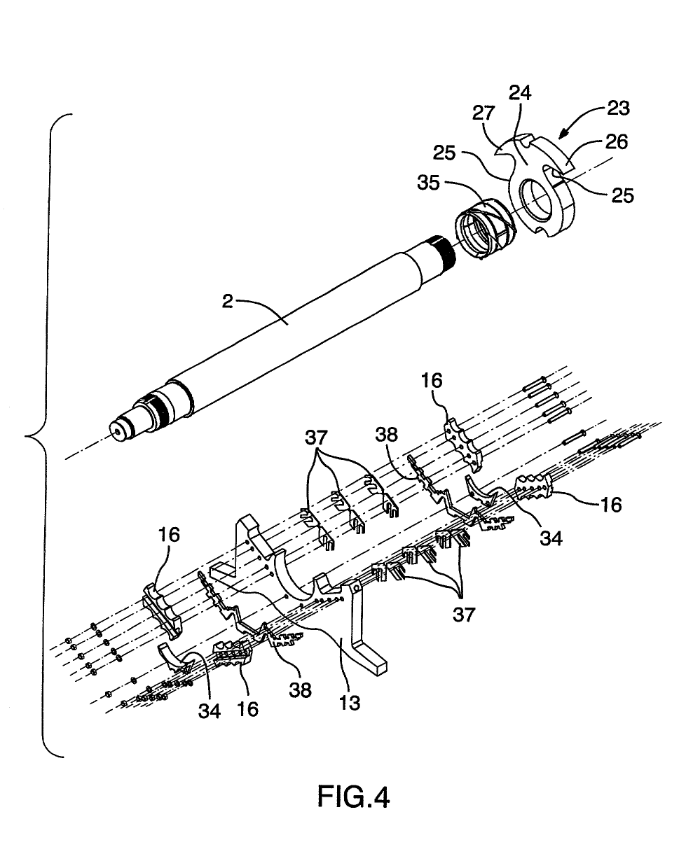

The frame has a cutter deck 36 which is slanted from the frame and the enclosure towards the shaft. The angle is advantageously between 30 and 45 degrees. The cutter deck meets the cross members 13 at a low position of the shaft, thereby minimizing the contact area between the shaft and the cross members to minimize the risk of shredded material or material to be shredded getting stuck between the shaft and the cross members. Each cracker jaw plate 16 is adjusted in position using any required number of shims 37 (see FIG. 4) to achieve the desired gap between the jaw plate and the adjacent cutter (approx. 0.060″ or less as desired). The gap between the cutter and a further adjacent cross member on the opposite side to the cracker jaw plate is kept larger than the gap between the cutter and the cracker jaw plate, to allow abrasive and high wear smaller particles to freely fall through without being processed limiting any undue wear and tear on the shredding apparatus. This larger gap also lets processed material fall through.

The cross members 13 advantageously have permanently fastened, for example welded, key plates 38 which have template edges which define the required position of both the cracker jaw plates 16 relative the cross member and the required position of the shaft strippers 34 relative the cross member.

The drive system 39 comprises either one or more electric motors or an internal combustion engine as prime mover. The prime mover provides pressurized hydraulic fluid to a hydraulic motor 41, which provides the rotation force to the shaft 2.

It will be appreciated that the above description relates to the preferred embodiment by way of example only. Many variations on the invention will be obvious to those knowledgeable in the field, and such obvious variations are within the scope of the invention as described and claimed, whether or not expressly described. For example, multiple shafts may be used in parallel to create a larger processing area, each shaft driven by its own hydraulic motor and regulated separately from other shafts, or multiple shaft units mechanically linked through gear means.

What is claimed as the invention is:

1. A shredding apparatus comprising:
a frame;
at least one shaft mounted on said frame, said at least one shaft reversibly rotatable around an axis of rotation in a first direction of rotation or a second direction of rotation;
at least one protruding cutter arranged on each said at least one shaft, each said at least one cutter having a stem portion, a first wedge-shaped tooth arranged on said stem portion and facing said first direction of rotation and a second wedge-shaped tooth arranged on said stem portion and facing said second direction of rotation, inner edges of said first tooth and said second tooth defining cutter shear edges; and
at least one jaw plate removably attached to said frame, said at least one jaw plate having a working surface a serrated edge, wherein material to be shredded is contacted by said first tooth or said second tooth, depending upon the direction of rotation of each said at least one shaft, then pushed towards said serrated edge of one of said at least one jaw plate, and second is pierced by said first tooth or said second tooth and then sheared between an edge of said working surface of said at least one jaw plate and one of said cutter shear edges.

2. The shredding apparatus as specified in claim 1, further comprising a drive means for rotating said at least one shaft.

3. The shredding apparatus as specified in claim 1, further comprising at least one cross member connecting sides of said frame, said at least one jaw plate removably attached to each said cross member.

4. The shredding apparatus as specified in claim 1, wherein said cracker jaw plates have a relief on a surface of said cracker jaw plates facing said cutter, to provide further jaw shearing edges to cooperate with the cutter shear edges.

5. The shredding apparatus as specified in claim 1, wherein said cutters are removably attached to each said at least one shaft.

6. The shredding apparatus as specified in claim 5, wherein said cutters are bolted to each said at least one shaft.

7. The shredding apparatus as specified in claim 1, wherein said cutters are welded to each said at least one shaft.

8. The shredding apparatus as specified in claim 3, wherein said cross members are removably attached to said frame.

9. The shredding apparatus as specified in claim 8, wherein said cross members are bolted to said frame.

10. The shredding apparatus as specified in claim 8, wherein said cross members are welded to said frame.

11. The shredding apparatus as specified in claim 3, wherein said cross members are attached to said frame by wedge means clamping said cross members.

12. The shredding apparatus as specified in claim 1, wherein said frame structure has an enclosure provided with a charging opening for material to be shredded, and a discharging opening for shredded material.

13. The shredding apparatus as specified in claim 2, wherein said drive means comprises at least one internal combustion engine.

14. The shredding apparatus as specified in claim 2, wherein said drive means comprises at least one electric motor.

15. The shredding apparatus as specified in claim 2, wherein said drive means comprises at least one hydraulic motor.

16. The shredding apparatus as specified in claim 1, further comprising extendable and retractable legs attached to said frame.

17. The shredding apparatus as specified in claim 1, wherein said first tooth and said second tooth have replaceable tips.

18. The shredding apparatus as specified in claim 10, wherein said enclosure has a door arranged in one side.
